(19) United States
(12) Patent Application Publication
(10) Pub. No.: US 2019/0063788 A1
(43) Pub. Date: Feb. 28, 2019

(54) AUTOMATED SOLAR COLLECTOR CLEANING DEVICE

(71) Applicant: SUNPOWER CORPORATION, San Jose, CA (US)

(72) Inventors: Michael CORSETTO, Davis, CA (US); Devin CASTELLUCCI, Woodland, CA (US)

(73) Assignee: SUN POWER CORPORATION, San Jose, CA (US)

(21) Appl. No.: 16/114,898

(22) Filed: Aug. 28, 2018

Related U.S. Application Data
(60) Provisional application No. 62/552,021, filed on Aug. 30, 2017.

(51) Int. Cl. F24S 40/20; H02S 40/10

(52) U.S. Cl. CPC F24S 40/20; H02S 40/10

(57) ABSTRACT

An autonomous solar collector cleaning device includes at least one main shaft, a first driver attached to a first end of the at least one main shaft, and a second driver attached to a second end of the at least one main shaft. The first and second drivers propel the cleaning device along a surface of the solar collector. A first sensor is attached to the first driver to detect an edge of the solar collector, and a second sensor is attached to the second driver to detect the edge of the solar collector. A control circuit maintains alignment of the cleaning device with respect to the solar collector based on outputs from the first and second sensors.

### CROSS-REFERENCE TO RELATED APPLICATIONS

This application claims the benefit of U.S. Provisional Patent Application No. 62/552,021, entitled Automated Solar Collector Cleaning Device and filed Aug. 30, 2017. The entire contents of this provisional application are incorporated herein by reference.

### BACKGROUND

The present disclosure is directed to an automated device for cleaning the surface of solar collectors, and associated methodologies.

Solar energy is rapidly emerging as a viable renewable energy source. Solar collectors convert solar energy into other useful forms, such as electricity or heat. Solar collectors are typically installed in sunny, dry areas in order to maximize the amount of light exposure and therefore the amount of power output. However, such areas can be windy and dusty, and over time dust may accumulate on the surface of the solar collectors. This accumulation of dust and dirt reduces the potential power output of the solar collectors.

Thus, to maintain a consistent power output, solar collectors need to be cleaned regularly to remove light-blocking debris. Traditional methods, such as handwashing, are time consuming and not always practical.

Therefore, there is a need for an automated cleaning device and associated method that is capable efficiently and effectively cleaning solar collectors. The devices and methods describe herein address at least these issues.

### SUMMARY

In one exemplary aspect, an autonomous solar collector cleaning device includes at least one main shaft, a first driver attached to a first end of the at least one main shaft, and a second driver attached to a second end of the at least one main shaft. The first and second drivers propel the cleaning device along a surface of the solar collector. A first sensor is attached to the first driver to detect an edge of the solar collector, and a second sensor is attached to the second driver to detect the edge of the solar collector. A control circuit maintains alignment of the cleaning device with respect to the solar collector based on outputs from the first and second sensors.

In another exemplary aspect, the autonomous solar collector cleaning device further includes a head mount to attach a cleaning member to the main shaft.

In a further exemplary aspect, the head mount includes a spring assembly to exert pressure on the cleaning member to maintain continuous contact between the cleaning member and the surface of the solar collector as the cleaning device moves along the surface of the solar collector.

In a still further exemplary aspect, the cleaning member is a squeegee.

In another exemplary aspect, the first and second drivers respectively grip the solar collector to counteract a normal force generated by the pressure exerted by the head mount.

In a further exemplary aspect, each of the first driver and the second driver include a set of upper wheels and a set of lower wheels that are spaced apart in order to grip the solar collector therebetween.

In yet another exemplary aspect, the first and second sensors are inductive sensors.

In still another exemplary aspect, the control circuit determines parameters to control the first and second drivers to maintain the alignment of the cleaning device based on a difference in time between detection of the edge of the solar collector by the first sensor and detection of the edge of the solar collector by the second sensor.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is an illustration of a device for cleaning solar collectors that is misaligned with the edges of the solar collector being cleaned;

FIG. 2 is an illustration of a device for cleaning solar collectors that is properly aligned with the edges of the solar collector being cleaned;

FIG. 3 is an illustration of a device for cleaning solar collectors according to exemplary aspects of the present disclosure;

FIG. 4 is another illustration of the device for cleaning solar collectors according to exemplary aspects of the present disclosure;

FIG. 5 is an illustration of a drive mechanism for the device according to exemplary aspects of the present disclosure;

FIG. 6 is another illustration of the drive mechanism for the device according to exemplary aspects of the present disclosure;

FIG. 7 is a three-dimensional illustration of the drive mechanism for the device according to exemplary aspects of the present disclosure;

FIG. 8 is an illustration of the top of the drive mechanism for the device according to exemplary aspects of the present disclosure;

FIG. 9 is an isometric illustration of the drive mechanism for the device according to exemplary aspects of the present disclosure;

FIG. 10 is an illustration of a head mount for the device according to exemplary aspects of the present disclosure;

FIG. 11 is an isometric illustration of the head mount for the device according to exemplary aspects of the present disclosure;

FIG. 12 is an illustration of the front of the head mount according to exemplary aspects of the present disclosure;

FIG. 13 is an illustration of the top of the head mount according to exemplary aspects of the present disclosure;

FIG. 14 is a schematic drawing of the control circuitry for the device according to exemplary aspects of the present disclosure; and

FIG. 15 is an algorithmic flow chart of the process carried out by the control circuitry according to exemplary aspects of the present disclosure.

### DETAILED DESCRIPTION

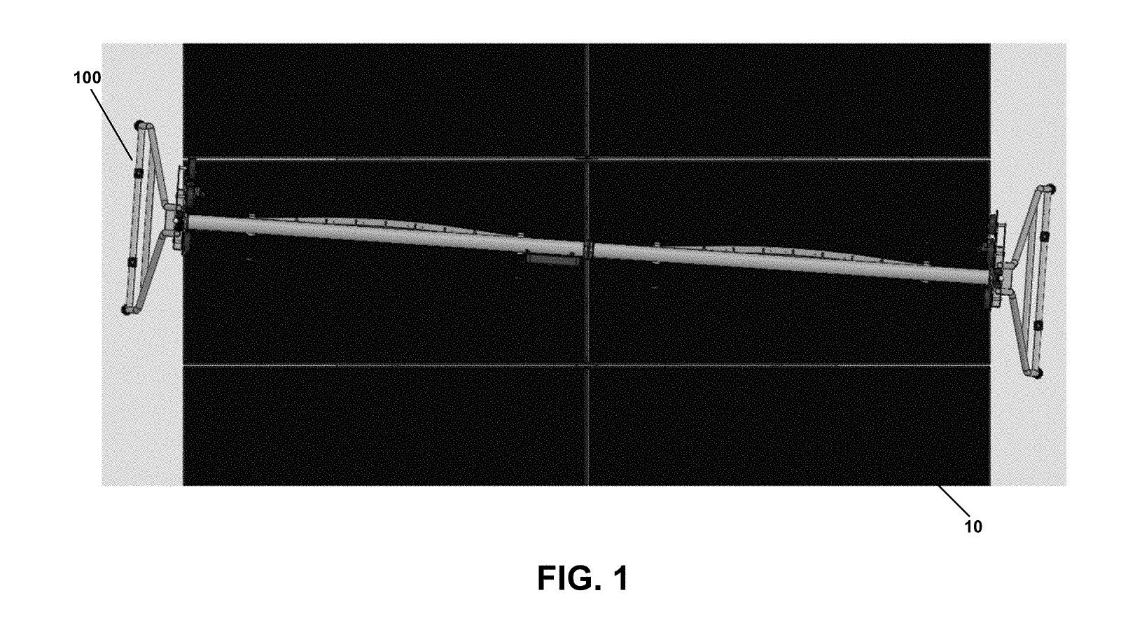

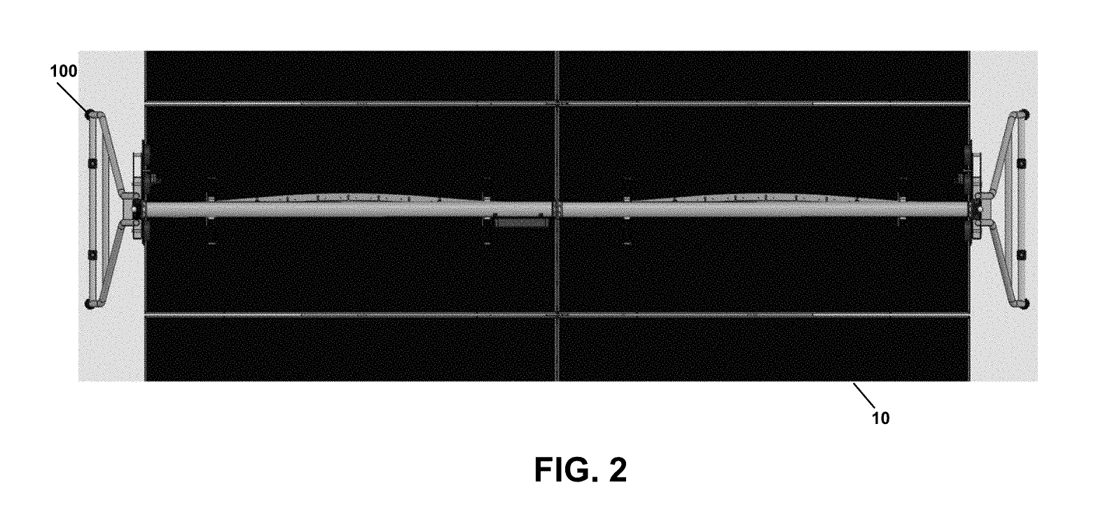

Referring now to the drawings, wherein like reference numerals designate identical or corresponding parts throughout the several views, FIG. 1 illustrates one of the challenges to cleaning solar collectors with an automated cleaning device. In FIG. 2, an automated cleaning device 100 moves across the face of a solar collector 10. As it does, the automated cleaning device 100 may spray a cleaning liquid using on-board nozzles, scrub the face of the solar collector 10 with on-board brushes, and then remove the cleaning liquid and any debris suspended therein with an on-board squeegee that, for example, spans an entire length of the solar collector 10. However, as illustrated in FIG. 1, the automated cleaning device may become misaligned relative to the edges of the solar collector 10. This can occur, for example, if the drive on one side of the automated cleaning device 100 moves at a faster (or slower) speed than the drive on the other side of the automated cleaning device 100. This misalignment may make the cleaning of the solar collector less efficient and/or less effective, and may even cause the automated cleaning device 100 to “bind” and become unable to continue moving across the face of the solar collector 10. Therefore, the automated cleaning device 100 should remain in alignment with respect to the edges of the solar collector 10, as illustrated in FIG. 2, in order to efficiently and effectively clean the surface of the solar collector 10.

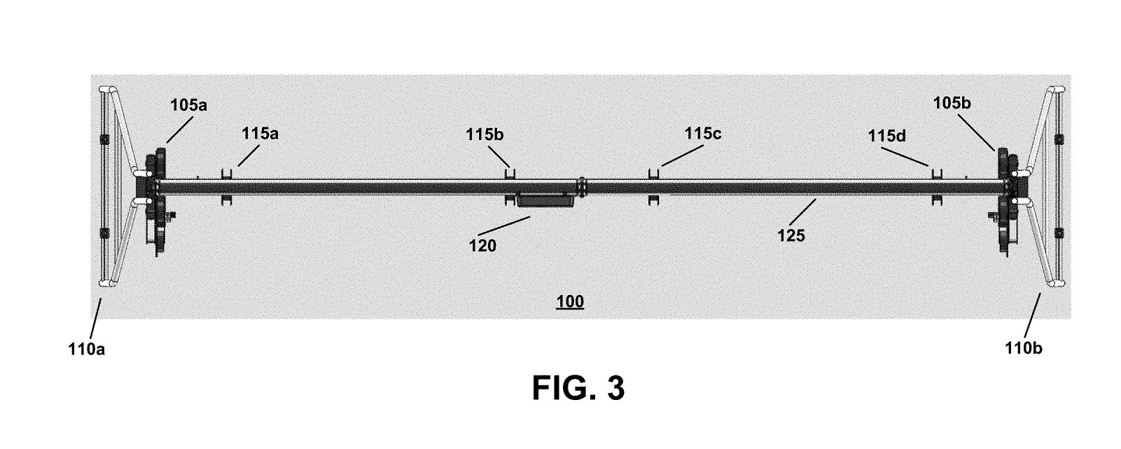

FIG. 3 is an illustration of an automated cleaning device 100 according to exemplary aspects of the present disclosure. The device 100 includes a main shaft 125 with several mounting points 115a, 115b, 115c, 115d (collectively referred to as 115) for mounting components such as those described below. The main shaft 125 also includes a control unit 120 in which control circuitry such as the one described below is housed.

As illustrated in FIG. 3, there are drive units 105a and 105b (collectively referred to as 105) attached to either end of the main shaft 125. The drive units 105 propel the device 100 along the surface of a solar collector (not shown) in order to clean the surface. A detailed description of the drive units 105 is provided below.

Optionally, attached to either end of the main shaft 125 are handles 110a and 110b used to initially position the automated cleaning device 100 on a solar collector and to remove the automated cleaning device 100 from the solar collector when the cleaning operation is finished. The handles 100a and 110b can also serve as stands to support the automated cleaning device 100 when not in use. The handles 110a and 110b may be 3 ft to 4 ft in length to facilitate placement of the automated cleaning device 100 on the surface of a solar collector without, for example, use of a ladder. Of course, the handles 110a and 110b may be of any other length without departing from the scope of the present disclosure.

As can be appreciated, the device 100 illustrated in FIG. 3 is merely exemplary, and other device structures are possible without departing from the scope of the present disclosure. For example, the device may have more than one shaft 125 in order to increase the width of the device 100 and its capability to carry additional cleaning modules (not shown). The main shaft 125 may also be made telescopic in order to accommodate solar collectors of varying widths. The telescopic main shaft 120 may be adjusted manually or automatically by the device 100 by sensing the edges of a solar collector as described in detail below. Other variations are also possible as would be recognized by those skilled in the art.

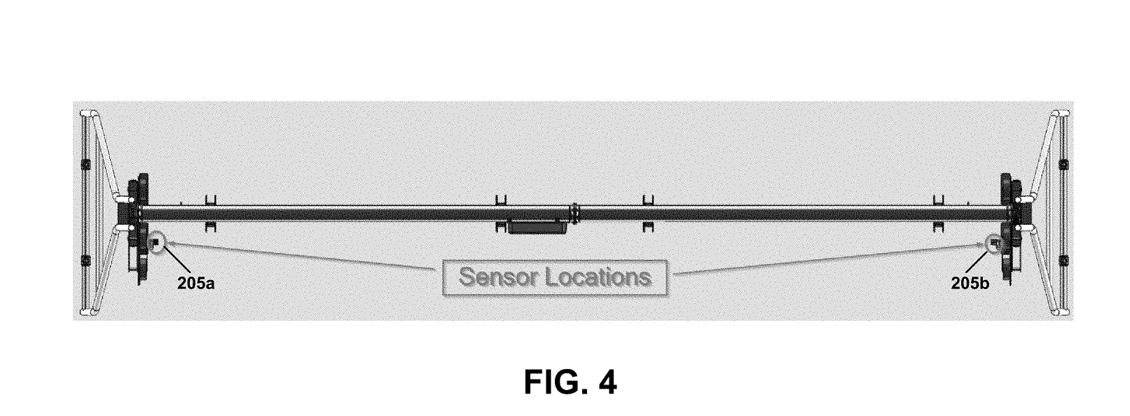

FIG. 4 is another illustration of the cleaning device 100. In FIG. 4, the device 100 includes the same components as described above. However, sensors 205a and 205b (collectively referred to as 205) are illustrated as being attached to the drive units 105. The sensors 205 detect the edges of the solar collector on which the device is placed. Upon detection, the sensors 205 generate signals that are provided to the control unit 120, which uses the signals to maintain alignment of the device 100 as it travels along the face of the solar collector.

For example, the control unit 120 may receive a first signal from sensor 205a indicating that this sensor has detected the edge of the solar collector. The control unit 120 may then start a timer, which is stopped once the control unit 120 receives a second signal from the sensor 205b indicating that this sensor has detected the edge of the solar collector. Since the sensors 205 are attached to the drive units 105, the timer value indicates the amount of misalignment between the two drive units 105. In this case, the timer value indicates that the drive unit 105b lags behind the drive unit 105a.

The control unit 120 may then generate control signals to the drive units 105 based on the time value. For example, the control unit 120 may send a signal to drive unit 105a to slow down in order to allow drive unit 105b to catch up. Alternatively, the control unit 120 may send a signal to drive unit 105b to speed up in order to catch up to drive unit 105a. Of course, any other method of motor control may be used in order to ensure that the drive units 105, and therefore the device 100, remain aligned as it progresses along the face of the solar collector.

The sensors in FIG. 4 may be inductive sensors that detect changes in electromagnetic fields caused by metallic objects, such as the frame of a solar collector. The sensors may also be optical sensors, infrared sensors, laser sensors, mechanical sensors that “feel” for the edge of the solar collector, or any other sensors that is known. Therefore, the specific sensor used in the device 100 to detect the edge of a solar collector is not limiting upon the present disclosure.

Although FIG. 4 illustrates the sensors 205 as being mounted on the drive units 105, the sensors 205 may also be located elsewhere. For example, the sensors 205 may be located at the center of the device 100, such as where the control unit 120 is located. From this location, sensors such as laser sensors, may detect the edges of the solar collector. Moreover, a combination of sensors may also be used, such as indicative sensors attached to the drive units 105 and one or more laser sensors located at the center of the device 100. Such an arrangement may allow for a more reliable detection of the edges of the solar collector. Thus, the specific location of the sensors and combination of sensors used is not limiting upon the present disclosure.

In addition, the sensors 205 may continuously provide signals to the control unit 120 indicating the position of the device 100 relative to the edges of the solar collector, or may provide the signals at predetermined times, or periodically. The control unit 120 may receive the signals by polling the sensors 205, or may receive the signals via interrupts generated when new signals from the sensors 205 become available. Any other method of providing the signals to the control unit 120 may also be used without departing from the present disclosure.

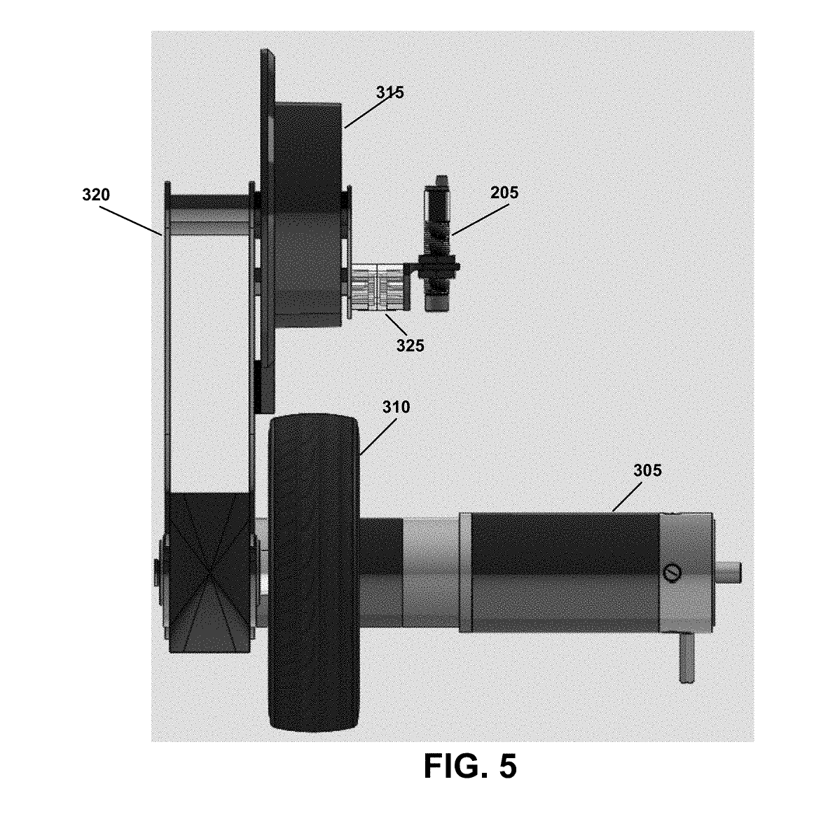

Next, FIG. 5 is a front illustration of the drive unit 105 that is attached to each end of the main shaft 125 of the device 100. As can be appreciated the drive unit 105a and 105b mirror, but are otherwise the same in construction. Therefore, description of only one drive unit 105 is provided for the sake of brevity.

The drive unit 105 includes a frame 320 to which drive wheels 310 are attached. The drive wheels 310 are driven by an electric motor 305 under control of the control unit 120. As can be appreciated, the electric motor 305 may directly drive the drive wheels 310, or may drive the drive wheels 310 via a belt, chain, and/or a series of gears. The drive wheels 310 ride along the bottom surface of the solar collector to propel the device 100, and may be made of solid rubber or may be inflatable. Regardless of the material from which the drive wheels 310 are made, the drive wheels 310 are designed to be compressible in order to grip the solar collector and resist slipping in wet conditions. The material of the drive wheels 310 can also be non-marking.

Upper wheels 315 are attached to the frame 320 above the drive wheels 310 so that a gap exists between the two wheels in order to receive the solar collector. This allows the drive units 105 to grip the solar collector as they propel the device 100 during cleaning, thereby compensating for the normal force created by the pressure exerted by the head mount on, for example a squeegee, as is explained in detail below.

The upper wheels in FIG. 5 are not driven by the electric motor 305. However, the upper wheels 315 can be driven by the electric motor 305 (or another electric motor that is not shown) directly, via a belt, chain, and/or a system of gears without departing from the scope of the present advancements. The upper wheels 315 may also be made of plastic, solid rubber, or may be inflatable. The upper wheels 315 also have flanges to help guide the device 100 as it moves along the surface of a solar collector.

The sensor 205 is attached to, and spaced apart from, the upper wheels 315 via an attachment mechanism 325. This way the sensor 205 rides just above the surface of the solar collector in order to be able to detect the edge thereof. As can be appreciated, the attachment mechanism 325 may be adjustable in multiple directions in order to allow calibration and proper positioning of the sensor 205. Moreover, the adjustment of the attachment mechanism may be manual, or may be automatically made by the control unit 120 in a calibration process executed prior to the start of cleaning of a solar collector.

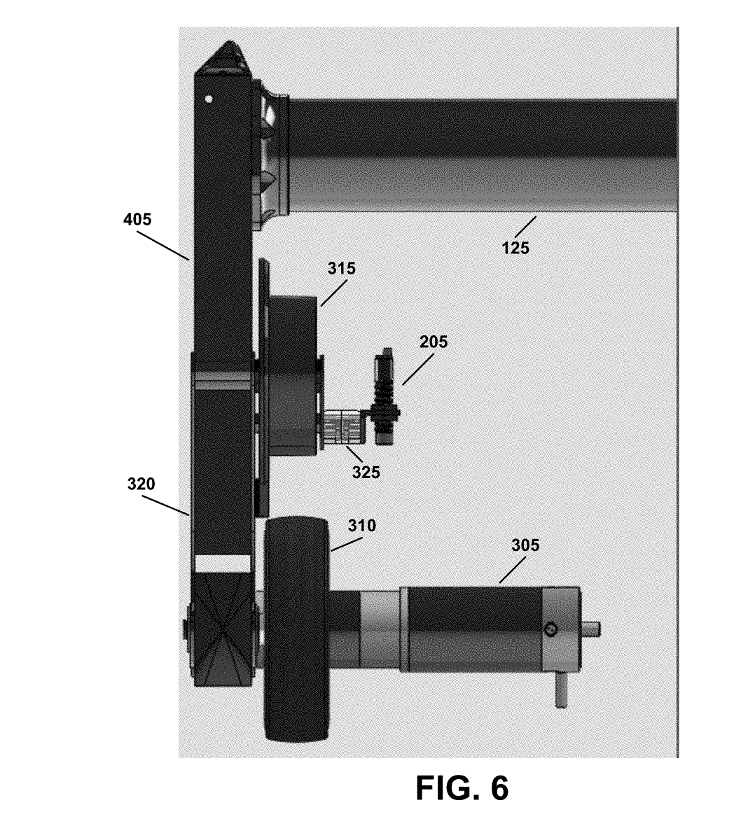

FIG. 6 is another view of the drive unit 105 according to exemplary aspects of the disclosure. As illustrated in FIG. 6, the main shaft 125 is attached to the frame 320 of the drive unit 105 by a mounting bracket 405. The mounting bracket may be adjustable to allow the height of the main shaft 125 relative to the upper surface of the solar collector to be varied in order to accommodate various types of cleaning components.

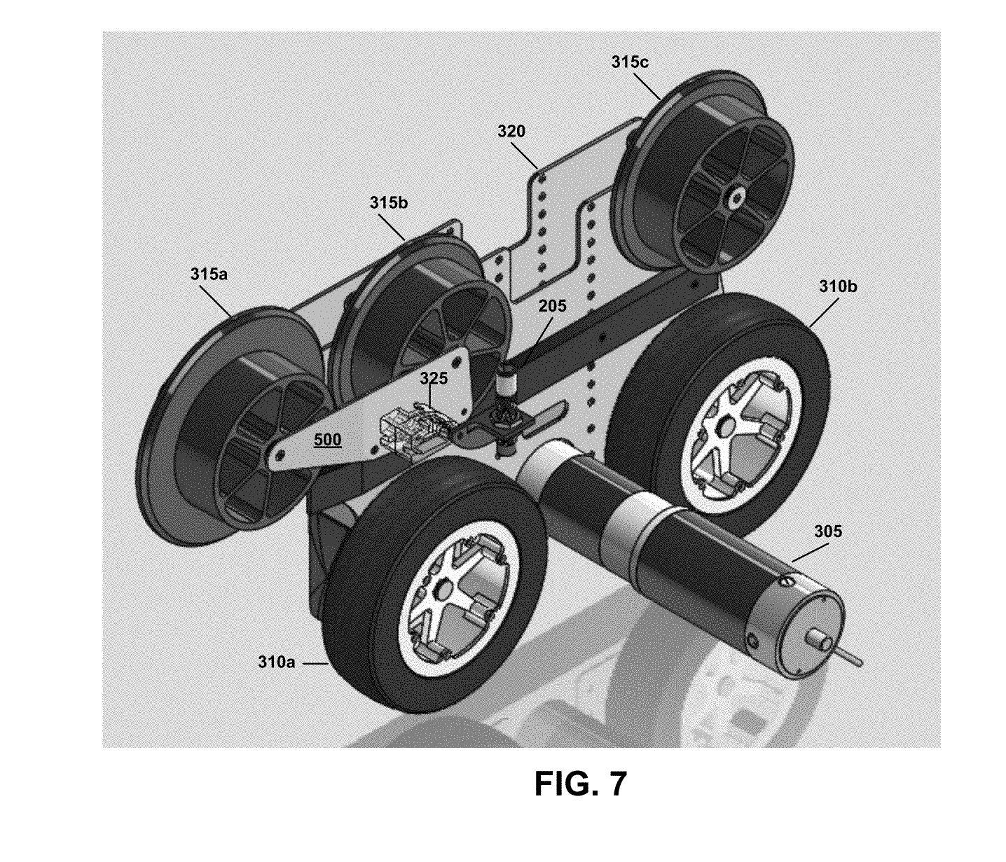

FIG. 7 is a further illustration of the drive unit 105. As can be seen from FIG. 7, the drive unit 105 includes three upper wheels 315a, 315b, 315c, and two drive wheels 310a, 310b. The electric motor 305 is mounted to the frame 320 between the two drive wheels 310a, 310b. One or both of the drive wheels 310a, 310b may be driven by the electric motor 305.

The attachment mechanism 325 includes a plate 500 that attaches to the axels of the upper wheels 315a and 315b in order to firmly hold the sensor 205 in place as the device moves 100. The attachment mechanism 325 is reinforced in order to resist flexing or moving as the device 100 travels along a solar collector in order to minimize detection errors.

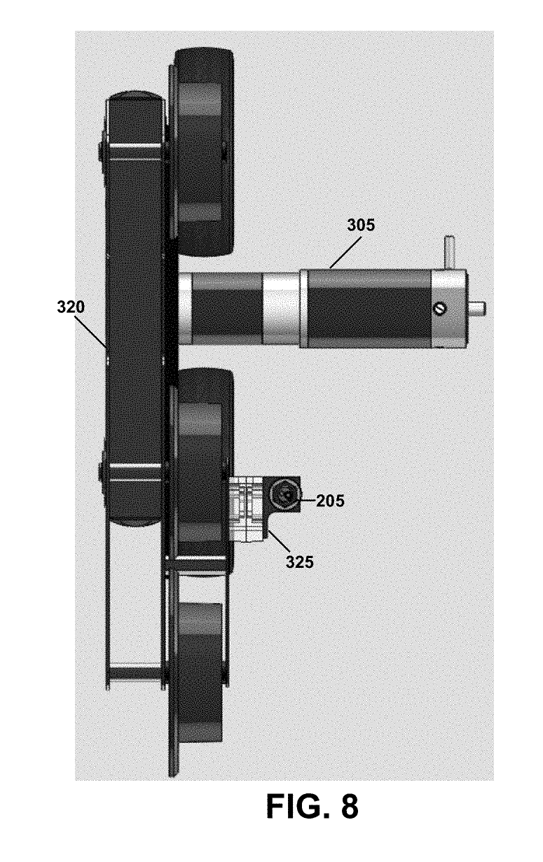

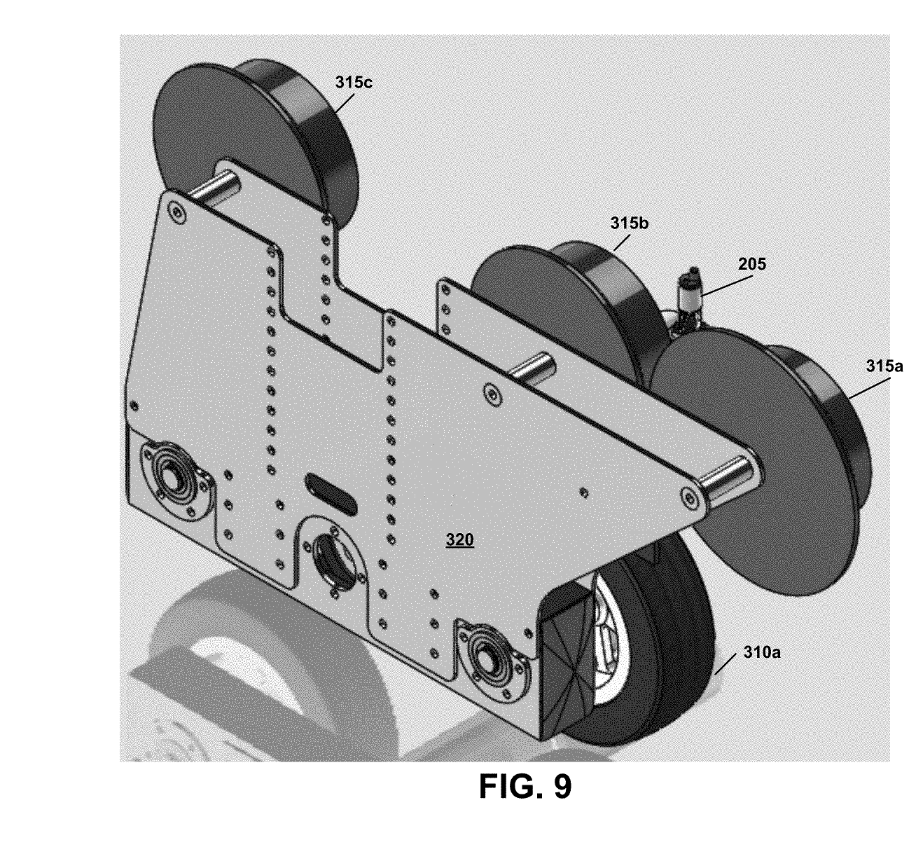

FIG. 8 is a top illustration of the drive unit 105, and FIG. 9 is an isometric illustration of the drive unit 105. As the components of the drive unit 105 were described above, further description of these components is omitted for brevity. However, it should be noted that the frame 320 of the drive unit 105 may be made of metal, aluminum, carbon fiber, Kevlar, reinforced plastic or any other material that provides sufficient strength and stiffness while remaining lightweight. Thus, the material from which the frame 320 of the drive unit 105 is made is not limiting upon the present disclosure.

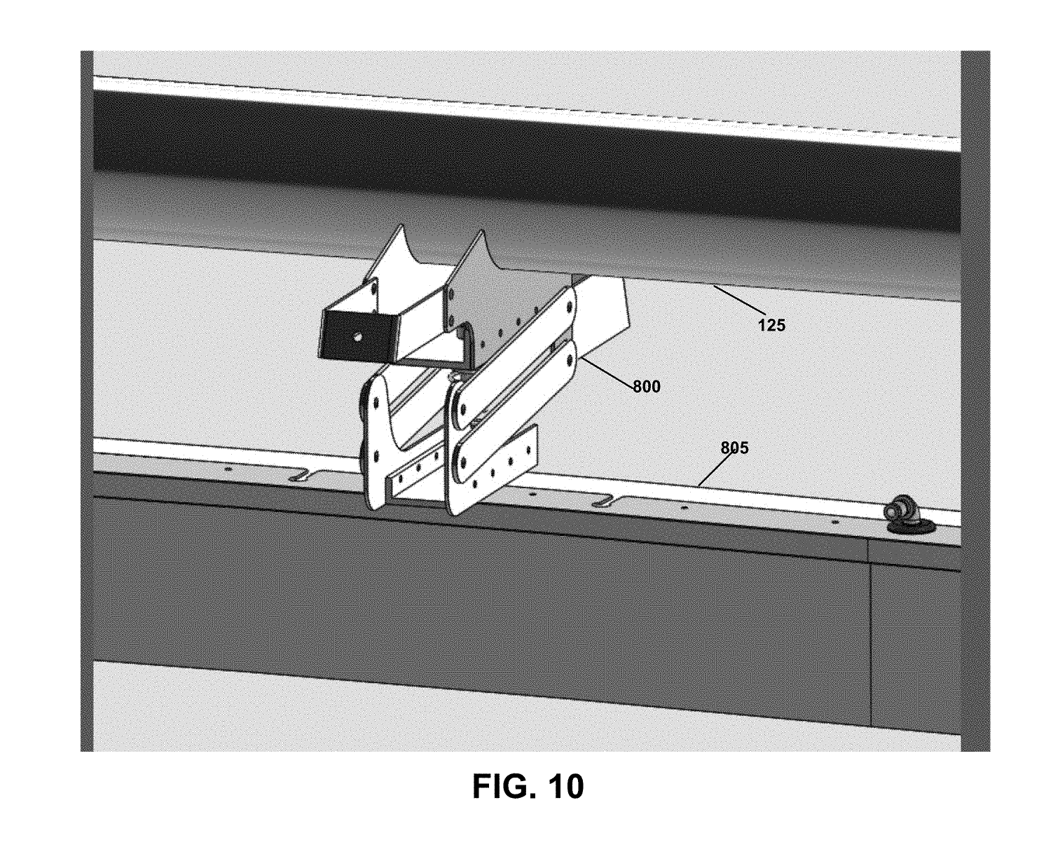

Next the head mount 800 is described with reference to FIG. 10. The head mount 800 attaches cleaning components to the main shaft 125 of the device 100. For example, in FIG. 10, the head mount 800 attaches a squeegee 805 to the main shaft 125 of the device 100. However, other cleaning components such as brushes, nozzle assemblies and vacuum assemblies can also be attached to the main shaft 125 by the head mount 800 without departing from the scope of the present disclosure. For example, a cleaning component may include an on-board reservoir that stores cleaning solution that is applied to the surface of a solar collector by the device 100 via an on-board nozzle assembly. Alternatively, a reservoir to store a cleaning solution may be located off-board. In this case, a nozzle connected to the off-board reservoir by a hose may be attached to the device 100 in order to deliver the cleaning solution to the surface of a solar collector. Thus the specific cleaning components, or modules, attached to the device 100 are in no way limiting upon the present disclosure.

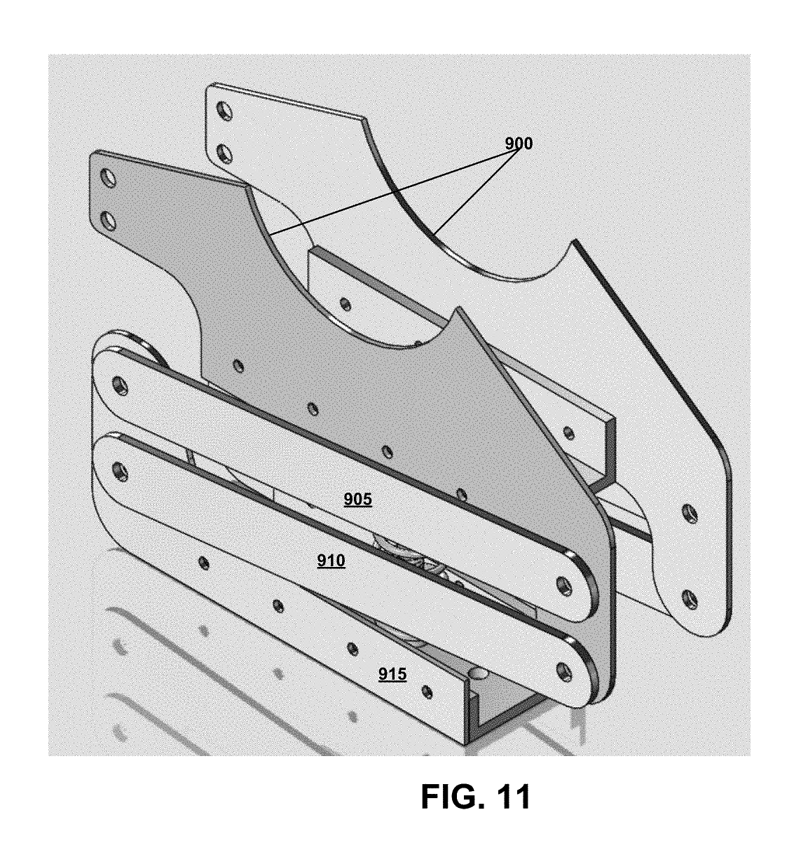

FIG. 11 is an isometric illustration of the head mount 800 according to exemplary aspects of the present disclosure. The head mount 800 includes plates 900 that have a curved edge to receive the main shaft 125. The plates 900 are respectively attached to ends of two metal members 905 and 910 which allow the plates 900 to rise and lower. The other ends of the metal members 905 and 910 are attached to a base member 915 which attaches to the cleaning component, such as the squeegee 805.

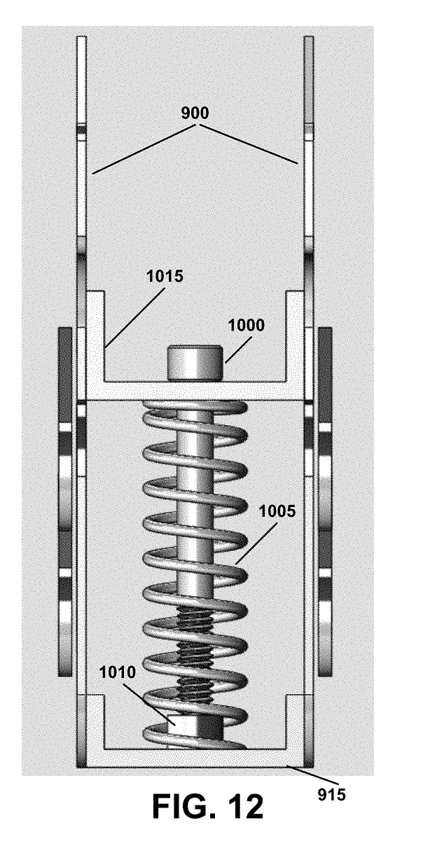

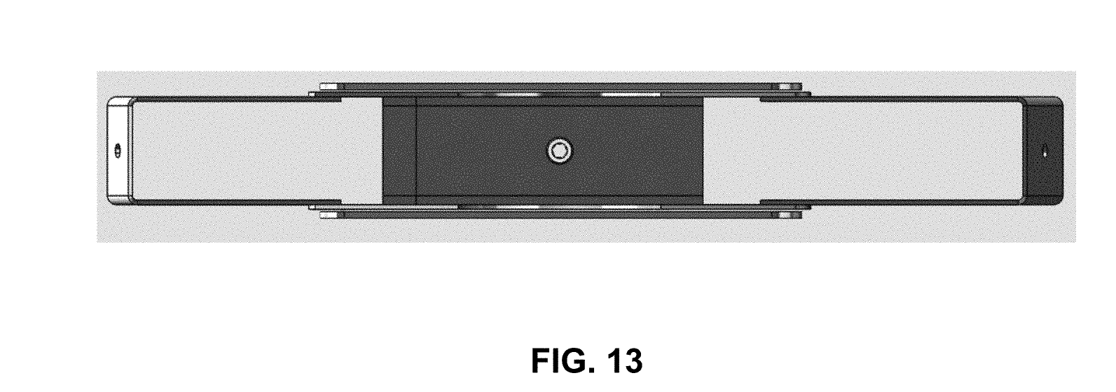

As can be seen from FIG. 12, the plates 900 are attached together by a member 1015 which is substantially similar to the base member 915. A bolt 1000 connects the member 1015 to a nut 1010 that is attached to the base member 915, and a spring 1005 surrounds the bolt 1000. The spring pushes against both the member 1015 and the base member 915 in order to expand the head mount 800, while the bolt 1000 limits the amount of possible expansion. In this way, the spring 1005 allows the head mount to exert sufficient pressure on, for example, the squeegee 805, to form a seal between the squeegee 805 and the surface of the solar collector. The spring 1005 is calibrated to exert the proper amount of force on the squeegee 805 to ensure constant contact between the squeegee 805 and the upper surface of the solar collector without “squishing” the squeegee against the top of the solar collector rendering the squeegee ineffective in removing liquid and debris. A top view of the head mount 800 in FIG. 13 illustrates the access to the bolt 1000 which can be tightened or loosened in order to allow the appropriate amount of expansion in the head mount 800.

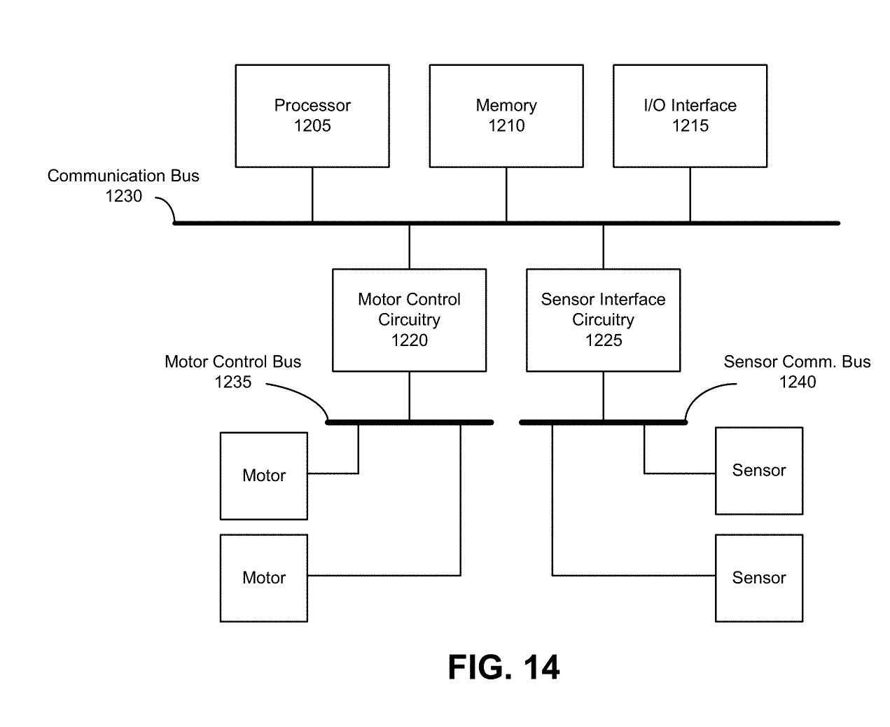

FIG. 14 is a schematic drawing of the control unit 120 of the device 100 according to exemplary aspects of the present disclosure. The control unit 120 includes a processor 1205 which can be an embedded microcontroller, a general purpose CPU, or a circuit specifically designed for the device 100 such as an FPGA or ASIC. The processor 1205 communicates with the other components of the control unit 120 via a communication bus 1230, which may use any protocol known in the art, for example, UART, USB, CAN, etc. A memory 1210 is also connected to the communication bus 1230 to store data and programming instructions used by the processor 1205. The memory may be any combination of RAM, ROM, EEPROM, SRAM, FLASH, etc., and at least a portion of the memory may be removable.

The control unit 120 also includes a sensor interface circuit 1225 which is connected to the communication bus 1230, and which is used to communicate with the sensors 205. This circuit includes all necessary components, such as filters, amplifiers, etc., to communicate with the sensors 205. The sensor interface circuit 1225 communicates with the sensors 205 via a sensor communication bus 1240, which may be a wired bus that employs any of the protocols identified above, or may be a wireless bus that uses protocols such as Bluetooth, Zigbee, WiFi, etc., to wirelessly communicate with the sensors 205. In the event that the sensor communication bus 1240 is wireless, the sensors 205 are powered via a separate power source as can be appreciated by those skilled in the art. If the sensor communication bus is a wired bus, the sensors 205 may derive power directly from the sensor communication bus 1240.

A motor control circuit 1220 is also connected to the communication bus 1230. The motor control circuit 1220 includes all necessary circuits to control the electric motors of the drive units 105, such as amplifiers, filters, and may implement control using lead, lag, lead/lag, PID and other control architectures as would be recognized by those skilled in the art. The motor control circuit 1220 communicates with the electric motors of the drive units 105 via a motor control bus 1235 which may be a 24 VDC bus through which power is supplied to the electric motors according to the control parameters provided to the motor control circuit 1220 by the processor 1205 via the communication bus 1230.

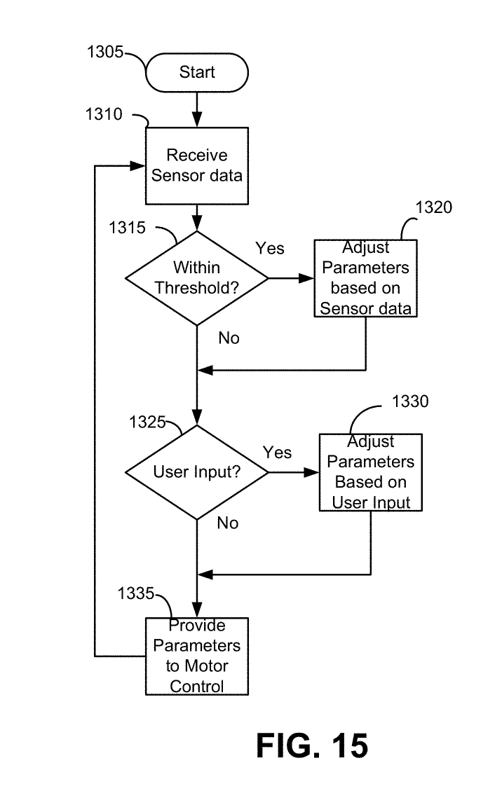

Next, a description of the process performed by the control unit 120 to ensure proper alignment of the device 100 during cleaning of a solar collector is provided with reference to FIG. 15. The process of FIG. 13 begins at step 1305 and proceeds to step 1310 in which sensor data is received from the sensors. The sensor data is analyzed at step 1315 to determine whether adjustment is needed. The analysis may include, for example, comparison of the difference in edge detection by both sensors 205 to a predetermined threshold.

If adjustment is not needed, the process moves to step 1325 in which it is determined whether user input is received. The user input may be a direction to cause the device 100 to move up/down a face of a solar collector, to stop, to move, etc. Thus, the user input is a general directive to the device 100, and the fine motor control of the device 100 is performed autonomously by the control unit 120. If no user input is detected at step 1325, then the process moves to step 1335 where motor control parameters are provided by the processor 1205 to the motor control circuitry 1220 in order to control movement of the device 100. Then the process reverts to step 1310.

If at step 1315 it is determined that adjustment is needed, then process moves to step 1320 to generate a new set of motor control parameters based on the difference in time between edge detection by the two sensors 205. These parameters may adjust the speed and or direction of movement of one or both of the drive units 105 in order to reduce the difference in time. Once the new parameters are generated, the process moves to step 1325 and follows the steps described above.

If at step 1325 it is determined that user input is received, the process moves to step 1330 to further adjust the control parameters based on the user input. Then the process moves to step 1335 to provide the adjusted parameters to the motor control circuit as described above.

Though in FIG. 15 the process is described using polling for receiving both sensor data and user input, other methods of receiving this data are also possible. For example, the process may be interrupt driven, especially with regard to user input which may be generated sporadically. The steps described with reference to FIG. 15 may also be performed in a different order than the one described, or even in reverse order. Therefore, FIG. 15 is merely an exemplary process and should in no way be interpreted as limiting upon the present disclosure.

Obviously, numerous modifications and variations of the present invention are possible in light of the above teachings. It is therefore to be understood that within the scope of the appended claims, the invention may be practiced otherwise than as specifically described herein.

1. An autonomous solar collector cleaning device, comprising:
at least one main shaft;
a first driver attached to a first end of the at least one main shaft;
a second driver attached to a second end of the at least one main shaft, the first and second drivers being configured to propel the autonomous solar collector cleaning device along a surface of the solar collector;
a first sensor attached to the first driver and configured to detect an edge of the solar collector;
a second sensor attached to the second driver and configured to detect the edge of the solar collector; and
a control circuit configured to maintain alignment of the autonomous solar collector cleaning device with respect to the solar collector based on outputs from the first and second sensors.

2. The autonomous solar collector cleaning device according to claim 1, wherein the edge detected by the first and second sensors is perpendicular to a direction of travel of the autonomous solar collector cleaning device.

3. The autonomous solar collector cleaning device according to claim 1, further comprising a head mount configured to attach a cleaning member to the main shaft.

4. The autonomous solar collector cleaning device according to claim 3, wherein the head mount includes a spring assembly configured to exert pressure on the cleaning member to maintain continuous contact between the cleaning member and the surface of the solar collector as the autonomous solar collector cleaning device moves along the surface of the solar collector.

5. The autonomous solar collector cleaning device according to claim 4, wherein the cleaning member is a squeegee.

6. The autonomous solar collector cleaning device according to claim 4, wherein the cleaning member includes a liquid reservoir and a nozzle configured to spray liquid from the liquid reservoir onto the surface of the solar collector.

7. The autonomous solar collector cleaning device according to claim 4, wherein the first and second drivers are respectively configured to grip the solar collector to counteract a normal force generated by the pressure exerted by the head mount.

8. The autonomous solar collector cleaning device according to claim 7, wherein each of the first driver and the second driver include a set of upper wheels and a set of lower wheels that are spaced apart in order to grip the solar collector therebetween.

9. The autonomous solar collector cleaning device according to claim 1, wherein the first and second sensors are inductive sensors.

10. The autonomous solar collector cleaning device according to claim 1, wherein the first and second sensors are optical sensors.

11. The autonomous solar collector cleaning device according to claim 1, wherein the first and second sensors are infrared sensors.

12. The autonomous solar collector cleaning device according to claim 1, wherein the first and second sensors are laser sensors.

13. The autonomous solar collector cleaning device according to claim 1, wherein the first and second sensors are mechanical sensors.

14. The autonomous solar collector cleaning device according to claim 1, wherein the control circuit determines parameters to control the first and second drivers to maintain the alignment of the autonomous solar collector cleaning device based on a difference in time between detection of the edge of the solar collector by the first sensor and detection of the edge of the solar collector by the second sensor.

15. The autonomous solar collector cleaning device according to claim 1, wherein the control circuit polls the first and second sensors to receive the outputs of the first and second sensors.

16. The autonomous solar collector cleaning device according to claim 1, wherein the control circuit receives the outputs of the first and second sensors via interrupts.

17. The autonomous solar collector cleaning device according to claim 1, wherein the outputs of the first and second sensors are continuous output signals.

18. The autonomous solar collector cleaning device according to claim 8, wherein the first and second drivers each include an electric motor mounted to a frame and coupled to at least one wheel of the upper and lower wheels.

19. The autonomous solar collector cleaning device according to claim 18, wherein in the first and second drivers, the electric motor is coupled to the at least one wheel via a belt.

20. The autonomous solar collector cleaning device according to claim 18, wherein in the first and second drivers, the electric motor is directly coupled to the at least one wheel.
